(19) United States
(12) Patent Application Publication
(10) Pub. No.: US 2010/0014905 A1
(43) Pub. Date: Jan. 21, 2010

(54) Compact ergonomic keyboard with central keypad

(76) Inventor: Charles Albert Morris, Maquoketa, IA (US)

Correspondence Address: Charles A. Morris, 612 S. 2nd St., Maquoketa, IA, 52060, US

(21) Appl. No.: 12/460,138

(22) Filed: Jul. 14, 2009

Related U.S. Application Data
(60) Provisional application No. 61/134,980, filed on Jul. 16, 2008.

(51) Int. Cl. B41J 5/00

(52) U.S. Cl. 400/489

(57) ABSTRACT

A compact ergonomic keyboard that places a raised input control pad at the center of the keyboard in order to maintain smaller lateral dimensions and prevent inadvertent engagement of the central input control pad. Placed between the left and right sections of the keyboard, said input control pad provides easy implementation of web browser commands, media commands, and direction controls. A raised miniature trackball or raised trackpad for cursor controls is also placed between the left and right sections. An alternate configuration achieves the same benefit by placing the input control pad and the trackball/trackpad at an elevation that is lower than the keys of the left and right sections.

### BACKGROUND OF THE INVENTION

The present invention relates to a compact ergonomic computer keyboard that separates the left and right sections of the keyboard.

Numerous embodiments of ergonomic computer keyboards exist in the prior art in which a left section and a right section of the keyboard are separated with various keys, trackballs, scrollwheels, or trackpads placed between the left and right sections (U.S. Pat. No. 5,731,808, U.S. Pat. No. 5,318,367, U.S. Pat. No. 6,224,279, U.S. Pat. No. D387,340, U.S. Pat. No. D357,011, U.S. Pat. No. D341,134) or with no input controls between the left and right sections (U.S. Pat. No. 5,612,691, U.S. Pat. No. 6,022,156).

In U.S. Pat. No. 6,111,527 the overall keyboard retains more compact dimensions by allowing left and right sections of the keyboard to separate by rolling on tracks to reveal input keys on a body that is set at a lower elevation than the left and right halves. For use in folding portable keyboards that allow two-handed typing with standard dimension keys, the space-savings are minimized by keeping the left and right halves straight relative to each other as they are opened and closed. For non-folding, desktop keyboards, the rolling mechanism consumes time and adds moving parts that could break down.

My U.S. Pat. No. 6,869,289 provides the basis for several dependent claims that result in new art in conjunction with the independent claims in this application.

It would be advantageous to provide a more compact ergonomic computer keyboard in which an input control pad is conveniently located between the left and right sections, but in which the gap between the left and right sections is minimized without causing inadvertent engagement of the input control pad.

### BRIEF SUMMARY OF THE INVENTION

It is an object of the invention to provide a more compact ergonomic computer keyboard in which command keys are located between the left and right sections of the keyboard, but in which the gap between the left and right sections is minimized by placing the command keys at a higher elevation than the keys of the left section and the right section in order to prevent inadvertent engagement of the command keys.

It is a further object of the invention to provide a modified form of construction in which command keys are located between the left and right sections of the keyboard, but in which the gap between the left and right sections is minimized by placing the command keys at a lower elevation than the keys of the left section and the right section in order to prevent inadvertent engagement of the command keys, and in which the left and right sections of the keyboard are separately hinged to a center body that houses the center input control pad, such that the left and right sections can rotate into a position in which they are adjacent to each other.

It is a further object of the invention to provide a modified form of construction in which the left and right sections of the keyboard and the center input control pad are built into a laptop computer.

It is a further object of the invention to provide a modified form of construction in which the left and right sections of the keyboard and the center input control pad are built into a tablet computer.

It is a further object of the invention to provide a modified form of construction in which the left and right sections of the keyboard and the center input control pad are built into a body that houses a retractable display screen.

It is a further object of the invention to provide a modified form of construction in which the left and right sections of the keyboard are separately hinged to a center body that houses the center input control pad, such that the left and right sections can rotate into a closed position in which they are adjacent to each other, and in which the center body includes an extension that reaches away from the typist and includes a pivoting hinge by means of which a display screen rotates from a folded position adjacent to the closed left and right sections of the keyboard to a position suitable for viewing and use in conjunction with the keyboard, and wherein the pivoting hinge allows the display screen to be placed in a stored position in one of two ways: with the display screen facing the folded keyboard or with the display screen facing away from the folded keyboard.

It is a further object of the invention to provide a modified form of construction in which the left and right sections of the keyboard are separately hinged to a center body that houses the center input control pad, such that the left and right sections can rotate into a closed position in which they are adjacent to each other, and in which the center body includes an extension that reaches away from the typist and includes a pivoting hinge by means of which a computerized device with a touch-sensitive display screen rotates from a folded position adjacent to the closed left and right sections of the keyboard to a position suitable for viewing and use in conjunction with the keyboard, and wherein the pivoting hinge allows the computerized device with a touch-sensitive display screen to be placed in a stored position in one of two ways: with the display screen facing the folded keyboard or with the display screen facing away from the folded keyboard, and wherein the body that houses the computerized device with a touch-sensitive display screen can be detached by way of a release mechanism from the pivoting hinge such that the computerized device with a touch-sensitive display screen can be used without said keyboard.

It is a further object of the invention to provide a modified form of construction in which the left and right sections of the keyboard are separately hinged to a center body that houses the center input control pad, such that the left and right sections can rotate into a closed position in which they are adjacent to each other, and in which the center body includes an extension that reaches away from the typist and includes a hinge by means of which a holder for a PDA or smartphone rotates from a folded position adjacent to the closed left and right sections of the keyboard to a position suitable for holding a PDA or smartphone for use in conjunction with the keyboard.

It is a further object of the invention to provide a modified form of construction in which the left and right sections of the keyboard are separately hinged to a center body that houses the center input control pad, such that the left and right sections can rotate into a closed position in which they are adjacent to each other, and in which the center body includes a hinge on the side of the center body facing the typist, by means of which a body containing a trackpad is attached and can be unfolded for use with the keyboard.

It is a further object of the invention to provide a modified form of construction in which a miniature display projector is housed within the keyboard.

It is a further object of the invention to provide a modified form of construction in which a trackpad is located in the input control pad between the left and right sections of the keyboard.

It is a further object of the invention to provide a modified form of construction in which a trackball is located in the input control pad between the left and right sections of the keyboard.

It is a further object of the invention to provide a modified form of construction in which a scroll wheel is located in the input control pad between the left and right sections of the keyboard.

It is a further object of the invention to provide a modified form of construction in which the left and the right half of the keyboard each consist of only a home row of depressible keys, such that, when the keyboard is placed on a touchscreen, images of keys appear on the touchscreen, arrayed around the keyboard such that the sections of the touchscreen indicated by the images of keys provide all other keys of the keyboard.

It is a further object of the invention to provide a modified form of construction in which the left and the right half of the keyboard each consist of only a home row of four depressible keys located on an arm that has a hole between the depressible keys and the center input control pad, such that, when the keyboard is placed on a touchscreen, images of keys appear on the touchscreen, arrayed all around the left and right half of the keyboard such that the sections of the touchscreen indicated by the images of keys provide all other keys of the keyboard.

It is a further object of the invention to provide a modified form of construction in which the left and right sections of the keyboard are separately attached by way of a pivot to a center body that houses an input control pad, such that the left and right sections can rotate into a closed position in which they are adjacent to each other, and in which a body containing a trackpad is connected by a hinge to the central body, said hinge being located on the side of the central body facing a user of the keyboard, said hinge providing movement of the body containing a trackpad back and forth between a functioning position in which the body containing a trackpad is closer to the user of said keyboard than the central body and such that the body containing a trackpad can be folded into a stored position on top of a right section and a left section of the keyboard when the right and left sections have been rotated together into a stored position adjacent to each other lengthwise.

It is a further object of the invention to provide a modified form of construction in which the left and right sections of the keyboard are separately attached by way of a pivot to a center body that houses an input control pad, such that the left and right sections can rotate into a closed position in which they are adjacent to each other, and in which a body containing a trackpad is connected by a hinge to the central body, said hinge being located on the side of the central body facing a user of the keyboard, said hinge providing movement of the body containing a trackpad back and forth between a functioning position in which the body containing a trackpad is closer to the user of said keyboard than the central body and such that the body containing a trackpad can be folded into a stored position on top of a right section and a left section of the keyboard when the right and left sections have been rotated together into a stored position adjacent to each other lengthwise, and in which the center body includes an extension that reaches away from the typist and includes a hinge by means of which a holder for a PDA or smartphone rotates from a folded position adjacent to the closed body containing a trackpad to a position suitable for holding a PDA or smartphone for use in conjunction with the keyboard.

It is a further object of the invention to provide a modified form of construction in which the left and right sections of the keyboard are separately attached by way of a pivot to a center body that houses an input control pad, such that the left and right sections can rotate into a closed position in which they are adjacent to each other, and in which a body containing a trackpad is connected by a hinge to the central body, said hinge being located on the side of the central body facing a user of the keyboard, said hinge providing movement of the body containing a trackpad back and forth between a functioning position in which the body containing a trackpad is closer to the user of said keyboard than the central body and such that the body containing a trackpad can be folded into a stored position on top of a right section and a left section of the keyboard when the right and left sections have been rotated together into a stored position adjacent to each other lengthwise, and in which the center body includes an extension that reaches away from the typist and includes a pivoting hinge by means of which a display screen rotates from a folded position adjacent to the closed body containing a trackpad to a position suitable for viewing and use in conjunction with the keyboard, and wherein the pivoting hinge allows the display screen to be placed in a stored position in one of two ways: with the display screen facing the closed body containing a trackpad or with the display screen facing away from the closed body containing a trackpad.

### BRIEF DESCRIPTION OF THE SEVERAL VIEWS OF THE DRAWING

The present invention will be more fully understood by reference to the following detailed descriptions thereof when read in conjunction with the attached drawings, and wherein:

FIG. 1 is a perspective view of a preferred embodiment of the keyboard in accordance with the present invention in which a central touch-sensitive input control pad is placed at a higher elevation than the left and right sections of the keyboard, a trackball is housed between the left and right sections of the keyboard, the left and right sections of the keyboard are set at an oblique angle relative to each other, and only the home row keys and the space bar keys are depressible, with all other keys being touch-sensitive; and

FIG. 2 is a perspective view of a modified form of construction of the keyboard in accordance with the present invention in which a center touch-sensitive input control pad is placed at a higher elevation than the left and right sections of the keyboard, a trackball and a scroll wheel are housed between the left and right sections of the keyboard, the left and right sections of the keyboard are set at an oblique angle relative to each other, and only the home row keys and the space bar keys are depressible, with all other keys being touch-sensitive; and

FIG. 3 is a perspective view of a still further modified form of construction of the keyboard in accordance with the present invention in which the left and right sections of the keyboard are separately housed and are each separately attached by way of a sliding pivot to a central body such that they can be folded up together about the central body, and wherein touch-sensitive keys are housed within the central body, and wherein an extension on the central body has a pivoting hinge on its end, by means of which a display screen rotates upwards away from the keyboard for use in conjunction with the keyboard; and

FIG. 4 is a perspective view of a yet still further modified form of construction of the keyboard in accordance with the present invention in which the left and right sections of the keyboard are separately housed and are each separately attached by way of a hinge to a central body such that they can be folded up together about the central body, and wherein touch-sensitive keys are housed within the central body; and

FIG. 5 is a perspective view of a yet further modified form of construction of the keyboard in accordance with the present invention in which the keyboard is housed in a laptop computer; and

FIG. 6 is a perspective view of an even yet further modified form of construction of the keyboard in accordance with the present invention in which a miniature display projector is housed within the central section of the keyboard; and

FIG. 7 is a perspective view of a even yet still further modified form of construction of the keyboard in accordance with the present invention in which a flexible retractable display screen is housed within the keyboard and is shown unfurled for use; and

FIG. 8 is a perspective view of a still even further modified form of construction of the keyboard in accordance with the present invention in which the keyboard is housed in a tablet computer.

FIG. 9 is a perspective view of a yet still even further modified form of construction of the keyboard in accordance with the present invention in which the left and the right sections of the keyboard are each comprised of four depressible home row keys for the four fingers of each hand, and wherein a space bar is depressible, and wherein the keyboard works in conjunction with a touch screen, such that when the keyboard is place on the touch screen, images of keys appear on the screen surrounding the four home row keys on each section, said images of keys defining areas of the touch screen that can be touched to implement input of alphanumeric characters and commands, and wherein the center input control pad is raised higher than the left and right sections

FIG. 10 is a perspective view of a still even yet further modified form of construction of the keyboard in accordance with the present invention in which the left and the right sections of the keyboard are each comprised of seven depressible home row keys, and wherein a space bar is depressible, and wherein the keyboard works in conjunction with a touch screen, such that when the keyboard is place on the touch screen, images of keys appear on the screen above and below the home row keys on each section, said images of keys defining areas of the touch screen that can be touched to implement input of alphanumeric characters and commands, and wherein the center input control pad appears on the touch screen through an opening between the left an right sections.

FIG. 11 is a perspective view of another further modified form of construction of the keyboard in accordance with the present invention in which the left and right sections of the keyboard are separately attached by way of a pivot to a center body that houses an input control pad, such that the left and right sections can rotate into a closed position in which they are adjacent to each other, and in which a body containing a trackpad is connected by a hinge to the central body, said hinge being located on the side of the central body facing a user of the keyboard, said hinge providing movement of the body containing a trackpad back and forth between a functioning position in which the body containing a trackpad is closer to the user of said keyboard than the central body and such that the body containing a trackpad can be folded into a stored position on top of a right section and a left section of the keyboard when the right and left sections have been rotated together into a stored position adjacent to each other lengthwise.

FIG. 12 is a perspective view of a yet another further modified form of construction of the keyboard in accordance with the present invention in which the left and right sections of the keyboard are separately attached by way of a pivot to a center body that houses an input control pad, such that the left and right sections can rotate into a closed position in which they are adjacent to each other, and in which a body containing a trackpad is connected by a hinge to the central body, said hinge being located on the side of the central body facing a user of the keyboard, said hinge providing movement of the body containing a trackpad back and forth between a functioning position in which the body containing a trackpad is closer to the user of said keyboard than the central body and such that the body containing a trackpad can be folded into a stored position on top of a right section and a left section of the keyboard when the right and left sections have been rotated together into a stored position adjacent to each other lengthwise, and in which the center body includes an extension that reaches away from the typist and includes a hinge by means of which a holder for a PDA or smartphone rotates from a folded position adjacent to the closed body containing a trackpad to a position suitable for holding a PDA or smartphone for use in conjunction with the keyboard.

FIG. 13 is a perspective view of a still another further modified form of construction of the keyboard in accordance with the present invention in which the left and right sections of the keyboard are separately attached by way of a pivot to a center body that houses an input control pad, such that the left and right sections can rotate into a closed position in which they are adjacent to each other, and in which a body containing a trackpad is connected by a hinge to the central body, said hinge being located on the side of the central body facing a user of the keyboard, said hinge providing movement of the body containing a trackpad back and forth between a functioning position in which the body containing a trackpad is closer to the user of said keyboard than the central body and such that the body containing a trackpad can be folded into a stored position on top of a right section and a left section of the keyboard when the right and left sections have been rotated together into a stored position adjacent to each other lengthwise, and in which the center body includes an extension that reaches away from the typist and includes a pivoting hinge by means of which a compact computerized device with a display screen rotates from a folded position adjacent to the closed body containing a trackpad to a position suitable for viewing and use in conjunction with the keyboard, and wherein the pivoting hinge allows the compact computerized device to be placed in a stored position in one of two ways: with the display screen facing the closed body containing a trackpad or with the display screen facing away from the closed body containing a trackpad.

### DETAILED DESCRIPTION OF THE INVENTION

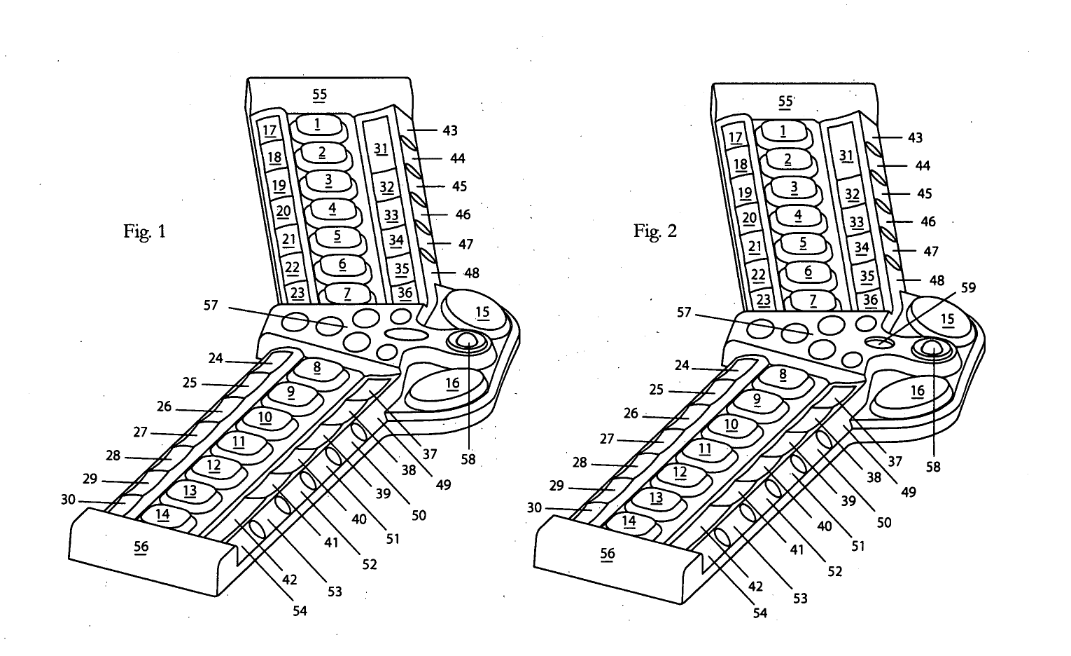

In FIG. 1, there is shown a perspective view of an example of the keyboard showing the depressible key switches 1-16 and the touch-sensitive key switches 17-54. Number 57 is the input control pad of touch-sensitive key switches that is located at the center of the keyboard an elevation that is higher than all other key switches 1-54. A trackball 58 is located at a higher elevation than and between the two space bars 15 and 16.

This keyboard is particularly useful for providing a more compact ergonomic keyboard, because it allows characters and commands to be conveniently engaged by using the input control pad 57 at the center of the keyboard without creating a large gap between the left section of the keyboard and the center input control pad 57 or between the right section of the keyboard and the center input control pad 57. This higher elevation helps to prevent inadvertent engagement of the center input control pad 57 when the typist is entering alphanumeric characters and commands. Similarly, the trackball 58 is set at a higher elevation in order to keep it close to the thumbs of the typist and to prevent inadvertent engagement when the typist is engaging the space bars 15 and 16.

In FIG. 2 there is shown a further example of the keyboard that places a scroll wheel 59 between the center input control pad 57 and the trackball 58. The scroll wheel 59 is set at a higher elevation than key switches 1-54 in order to prevent inadvertent engagement of the scroll wheel 59 when the typist is entering alphanumeric characters and commands.

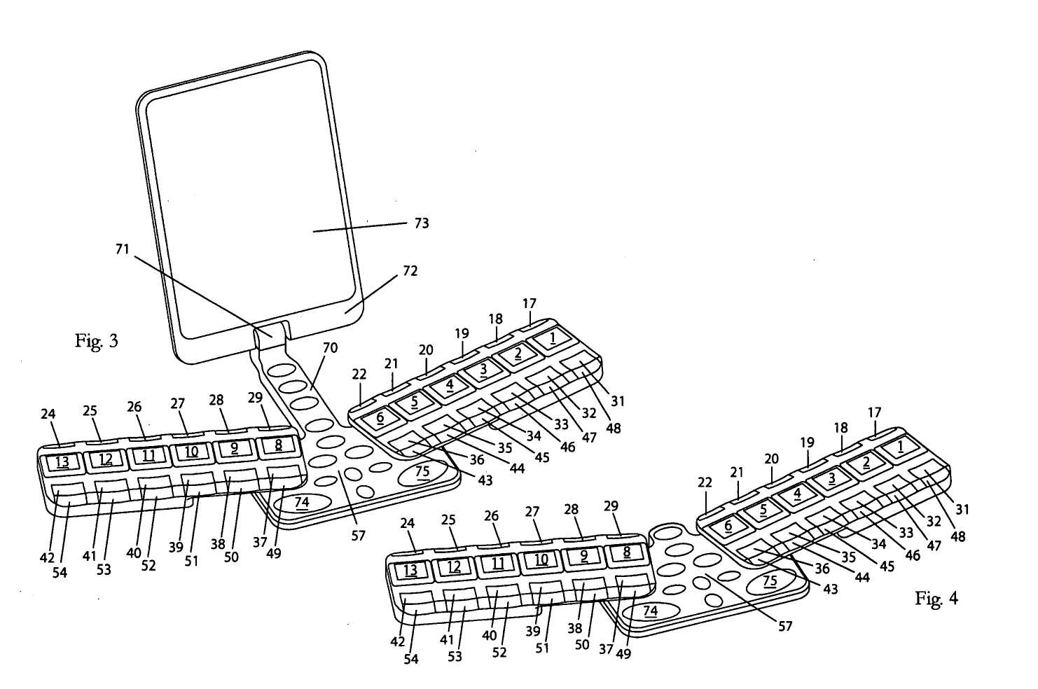

In FIG. 3 there is shown a further example of the keyboard in which the left and right sections of the keyboard are separately housed and are each separately attached by way of a sliding pivot to a central body such that they can be folded up together about the central body, and wherein a touch-sensitive input control pad 57 is housed within the central body, and wherein an extension 70 on the central body has a pivoting hinge 71 on its end, by means of which a body 72 that houses a display screen 73 rotates upwards away from the keyboard for use in conjunction with the keyboard.

In FIG. 4 there is shown a further example of the keyboard in which the left and right sections of the keyboard are separately housed and are each separately attached by way of a sliding pivot to a central body such that they can be folded up together about the central body, and wherein a touch-sensitive input control pad 57 and touch-sensitive space bar keys 74 and 75 are housed within the central body.

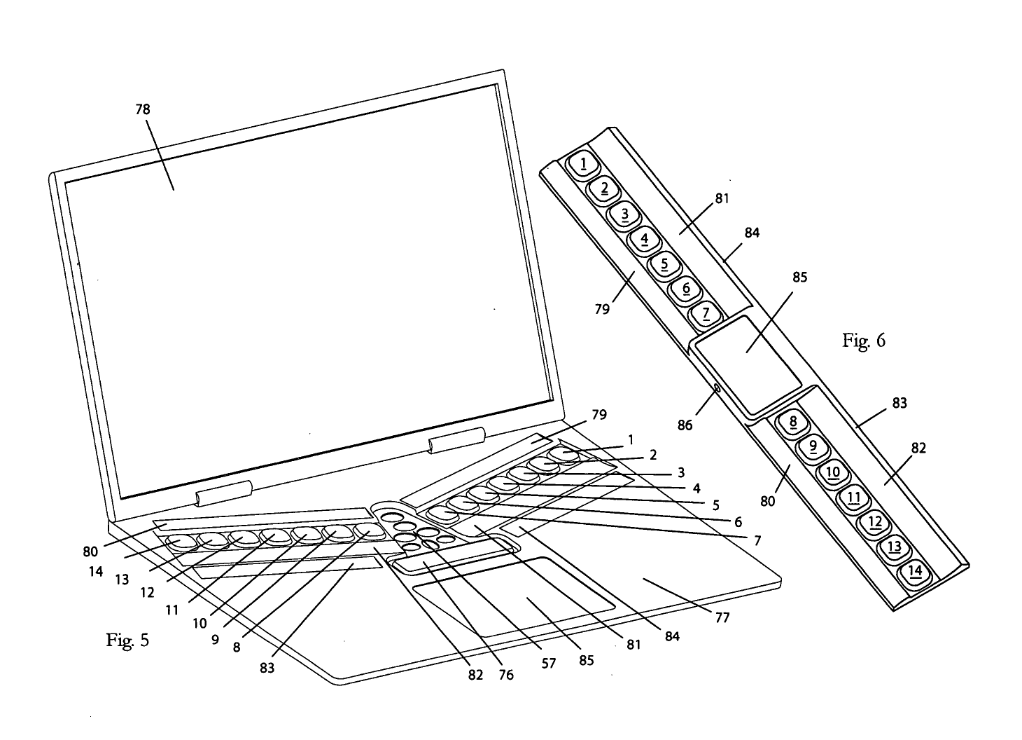

In FIG. 5 there is shown a further example of the keyboard in which the keyboard is housed in a laptop computer 77 with a display screen 78. The keyboard employs rows of touch-sensitive surfaces 79 and 80 above the home row of depressible keys 1-14. Specific characters and commands are assigned to distinct areas of these touch-sensitive surfaces 79 and 80. The keyboard also employs rows of touch-sensitive surfaces 81-84 below the home row of depressible keys 1-14. Specific characters and commands are assigned to distinct areas of these touch-sensitive surfaces 81-84. A depressible space bar 76 and a central touch-sensitive input control pad 57 are located between the left and right sections of the keyboard. The elevation of the central input control pad 57 is lower than all depressible key switches 1-14 and 76 as well as the touch-sensitive surfaces 79-84. A trackpad 85 is also housed in the laptop 77.

In FIG. 6 there is shown a further example of the keyboard in which a miniature display projector 86 is housed within the central section of the keyboard below a trackpad 85. The keyboard employs rows of touch-sensitive surfaces 79 and 80 above the home row of depressible keys 1-14. Specific characters and commands are assigned to distinct areas of these touch-sensitive surfaces 79 and 80. The keyboard also employs rows of touch-sensitive surfaces 81-84 below the home row of depressible keys 1-14. Specific characters and commands are assigned to distinct areas of these touch-sensitive surfaces 81-84.

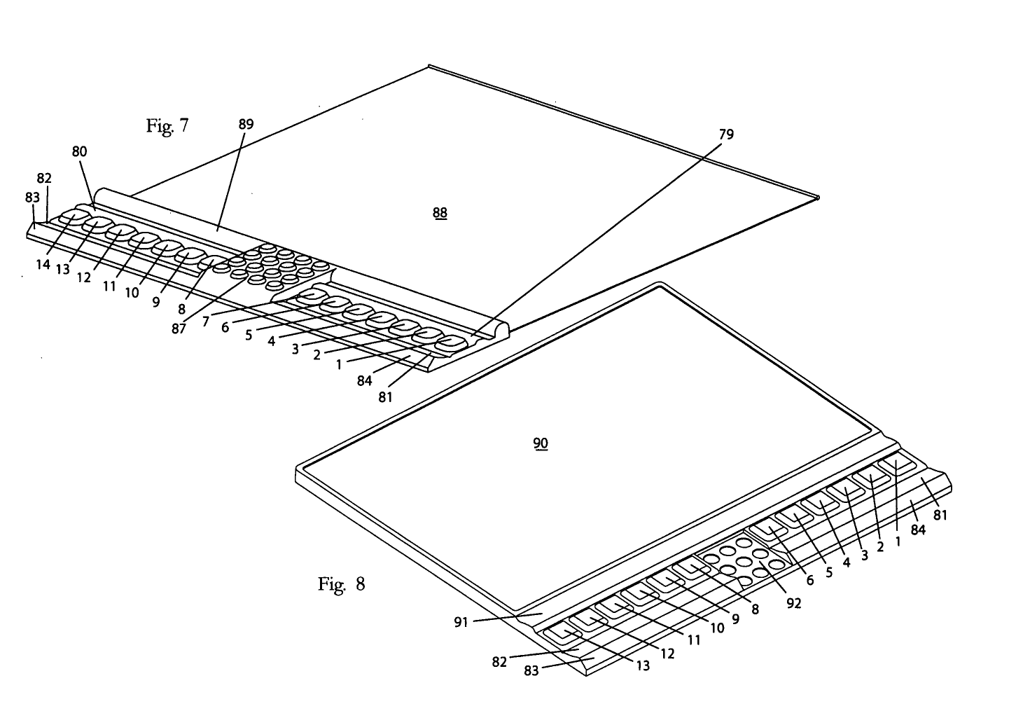

In FIG. 7 there is shown a further example of the keyboard in which a flexible retractable display screen 88 is housed within a compartment 89 that is located on the edge of the keyboard that is furthest from the typist. The flexible retractable screen 88 is shown unfurled for use with the keyboard. A central input control pad 87 is comprised of depressible keys that are located at a higher elevation than all other depressible key switches 1-14 and 76 as well as the touch-sensitive surfaces 79-84.

In FIG. 8 there is shown a further example of the keyboard in which the keyboard is housed in a tablet computer with a touch-sensitive display screen 90. The row of key switches above the depressible home row keys 1-6 and 8-16 is comprised of a touch-sensitive surface 91. A central touch-sensitive input control pad 92 is located between the left and right sections of the keyboard. The elevation of the central input control pad 92 is lower than all depressible key switches 1-6 and 8-13 as well as the touch-sensitive surfaces 81-84 and 91.

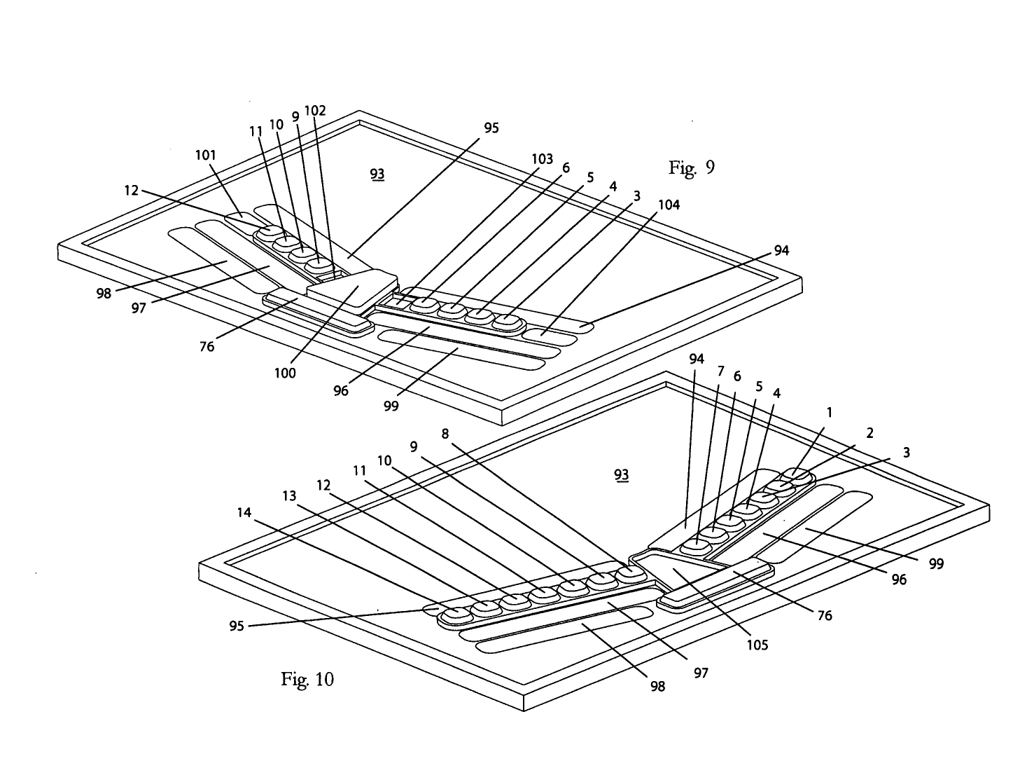

In FIG. 9 there is shown a further example of the keyboard in which the left and the right sections of the keyboard are each comprised of four depressible home row keys 3-6 and 9-12 for the four fingers of each hand, and wherein the keyboard works in conjunction with a touch screen 93, such that when the keyboard is place on the touch screen 93, images of keys appear on the screen surrounding the depressible home row keys 3-6 and 9-12 within areas of the touch screen 94-99 and 101-104 that can be touched to implement input of alphanumeric characters and commands, and wherein the center input control pad 100 is raised higher than the left and right sections.

FIG. 10 there is shown a further example of the keyboard in which the left and the right sections of the keyboard are each comprised of seven depressible home row keys 1-14, and wherein the keyboard works in conjunction with a touch screen 93, such that when the keyboard is place on the touch screen 93, images of keys appear on the screen above and below the depressible home row keys 1-14 within areas of the touch screen 94-99 that can be touched to implement input of alphanumeric characters and commands, and wherein the center input control pad appears within an area of the touch screen 105 that can be touched to implement input of alphanumeric characters and commands and that appears through an opening between the left an right sections.

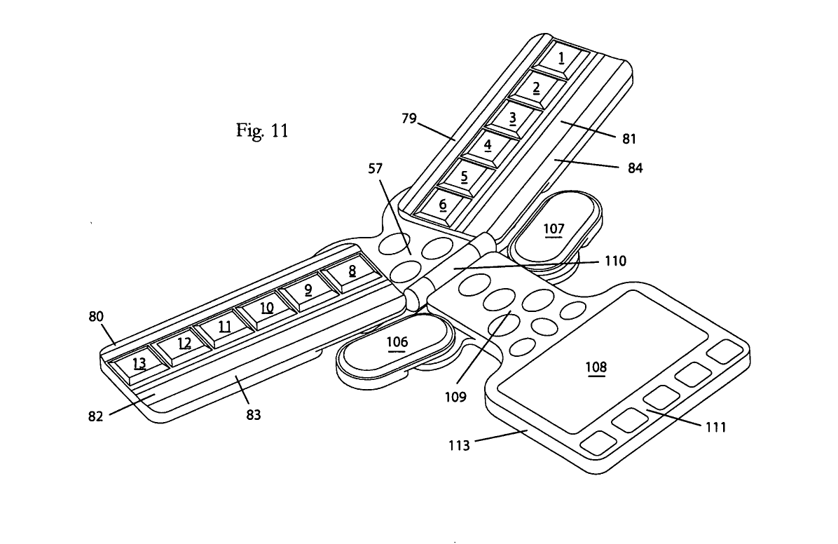

In FIG. 11 there is shown a further example of the keyboard in which the left and right sections of the keyboard are separately housed and are each separately attached by way of a sliding pivot to a central body such that the left and right sections can rotate into a closed position in which they are adjacent to each other. A touch-sensitive input control pad 57 is housed within the central body. An additional body 113 containing a trackpad 108 and additional touch-sensitive input control pads 109 and 111 is connected by a hinge 110 to the central body, said hinge 110 providing movement of the additional body 113 back and forth between a stored position and a functioning position in which the additional body 113 is closer to the user of said keyboard than the central body. The keyboard employs rows of touch-sensitive surfaces 79 and 80 above the home row of depressible keys 1-6, 8-13. Specific characters and commands are assigned to distinct areas of these touch-sensitive surfaces 79 and 80. The keyboard also employs rows of touch-sensitive surfaces 81-84 below the home row of depressible keys 1-14. Specific characters and commands are assigned to distinct areas of these touch-sensitive surfaces 81-84. The additional body 113 can be folded into a stored position on top of the right left sections of the keyboard when the right and left sections have been rotated together into a stored position adjacent to each other lengthwise. Depressible space bars 106 and 107 are each attached to the additional body 113 by way of a pivot and can be rotated into a more comfortable position according to the size of the typist's hands.

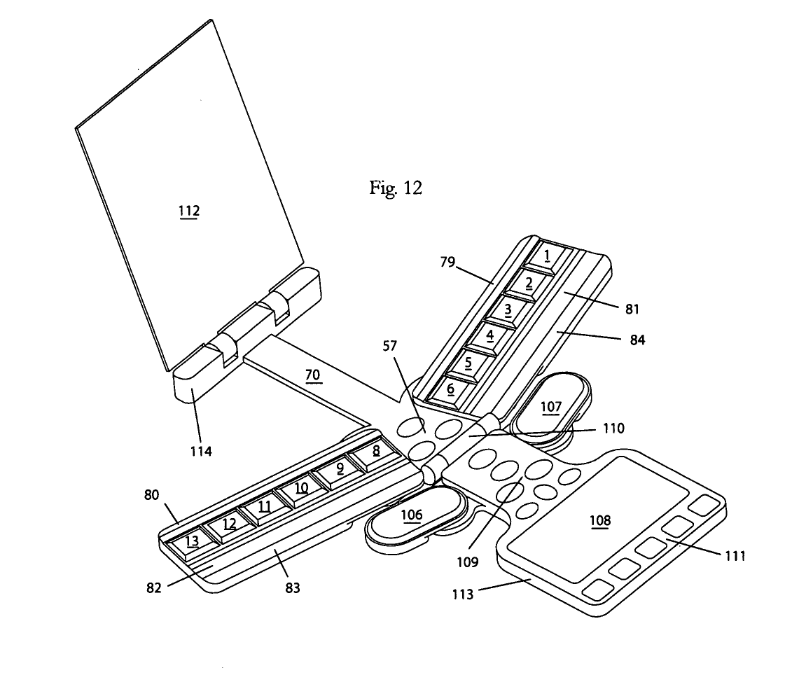

In FIG. 12 there is shown a further example of the keyboard in which the left and right sections of the keyboard are separately housed and are each separately attached by way of a sliding pivot to a central body such that the left and right sections can rotate into a closed position in which they are adjacent to each other. A touch-sensitive input control pad 57 is housed within the central body. An additional body 113 containing a trackpad 108 and additional touch-sensitive input control pads 109 and 111 is connected by a hinge 110 to the central body, said hinge 110 providing movement of the additional body 113 back and forth between a stored position and a functioning position in which the additional body 113 is closer to the user of said keyboard than the central body. The keyboard employs rows of touch-sensitive surfaces 79 and 80 above the home row of depressible keys 1-6, 8-13. Specific characters and commands are assigned to distinct areas of these touch-sensitive surfaces 79 and 80. The keyboard also employs rows of touch-sensitive surfaces 81-84 below the home row of depressible keys 1-14. Specific characters and commands are assigned to distinct areas of these touch-sensitive surfaces 81-84. The additional body 113 can be folded into a stored position on top of the right left sections of the keyboard when the right and left sections have been rotated together into a stored position adjacent to each other lengthwise. Depressible space bars 106 and 107 are each attached to the additional body 113 by way of a pivot and can be rotated into a more comfortable position according to the size of the typist's hands. The central body includes an extension 70 that reaches away from the typist and includes a hinge 114 by means of which a holder for a PDA or smartphone 112 rotates from a folded position adjacent to the closed additional body 113 to a position suitable for holding a PDA or smartphone for use in conjunction with the keyboard.

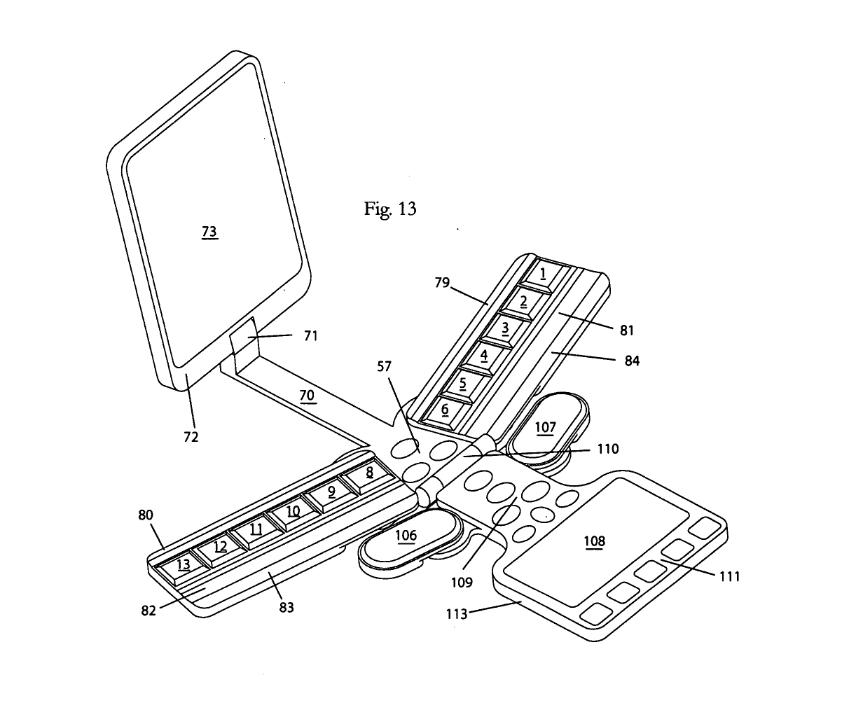

In FIG. 13 there is shown a further example of the keyboard in which the left and right sections of the keyboard are separately housed and are each separately attached by way of a sliding pivot to a central body such that the left and right sections can rotate into a closed position in which they are adjacent to each other. A touch-sensitive input control pad 57 is housed within the central body. An additional body 113 containing a trackpad 108 and additional touch-sensitive input control pads 109 and 111 is connected by a hinge 110 to the central body, said hinge 110 providing movement of the additional body 113 back and forth between a functioning position in which the additional body 113 is closer to the user of said keyboard than the central body. The keyboard employs rows of touch-sensitive surfaces 79 and 80 above the home row of depressible keys 1-6, 8-13. Specific characters and commands are assigned to distinct areas of these touch-sensitive surfaces 79 and 80. The keyboard also employs rows of touch-sensitive surfaces 81-84 below the home row of depressible keys 1-14. Specific characters and commands are assigned to distinct areas of these touch-sensitive surfaces 81-84. The additional body 113 can be folded into a stored position on top of the right left sections of the keyboard when the right and left sections have been rotated together into a stored position adjacent to each other lengthwise. Depressible space bars 106 and 107 are each attached to the additional body 113 by way of a pivot and can be rotated into a more comfortable position according to the size of the typist's hands. The central body includes an extension 70 that reaches away from the typist and includes a pivoting hinge 71 by means of which a compact computerized device 72 rotates from a folded position adjacent to the closed additional body 113 to a position suitable for viewing and use in conjunction with the keyboard. The pivoting hinge 71 allows the compact computerized device 72 to be placed in a stored position in one of two ways: with the display screen 73 facing the closed additional body 113 or with the display screen 73 facing away from the closed additional body 113.

I claim:

1. A keyboard for controlling data input of alphanumeric characters and other commands including in combination:
a right section of said keyboard having a plurality of key switches and a left section of said keyboard having a plurality of key switches, said right section and said left section of said keyboard being spaced apart from each other;
a central input control pad for controlling data input, said central input control pad being located between said right section and said left section of said keyboard, said central input control pad having an elevation that is higher than said key switches of said right section and said left section of said keyboard; and
means for coupling said central input control pad and all said key switches with a processing device.

2. The combination according to claim 1 wherein said keyboard is a non-folding desktop keyboard,
and wherein said right section and said left section of said keyboard are set at an oblique angle relative to each other, such that outer ends of said right section and said left section of said keyboard are set further away from a user of said keyboard than inner ends of said right section and said left section of said keyboard.

3. The combination according to claim 1 wherein said keyboard is a non-folding desktop keyboard,
and wherein said right section and said left section of said keyboard are set in a straight line relative to each other.

4. The combination according to claim 1 wherein a home row for each said right section and said left section of said keyboard have depressible keys,
and wherein a space bar is a depressible key set at a lower elevation than said central input control pad,
and wherein all other keys of said right section and said left section of said keyboard are engaged by means of proximity-sensors.

5. The combination according to claim 1 wherein a trackball is housed in the control pad between said right section and said left section of said keyboard.

6. The combination according to claim 1 wherein a trackpad is housed in the control pad between said right section and said left section of said keyboard.

7. The combination according to claim 1 wherein a scrollwheel is housed in the control pad between said right section and said left section of said keyboard.

8. The combination according to claim 1 wherein a miniature display projector is housed within said keyboard.

9. The combination according to claim 1 wherein a retractable, flexible display screen is housed within said keyboard.

10. The combination according to claim 1 wherein said right section of said keyboard is comprised of a single home row of depressible keys,
and wherein said left section of said keyboard is comprised of a single home row of depressible keys,
and wherein a space bar is a depressible key,
and wherein a touch-sensitive display screen can detect the presence of said keyboard when said keyboard is placed onto said touch-sensitive display screen,
and wherein images of keys appear on said touch-sensitive display screen when said keyboard is placed onto said touch-sensitive display screen, said images of keys being arrayed around said right section of said keyboard and said left section of said keyboard,
and wherein said images of keys arrayed around said right section of said keyboard and said left section of said keyboard move to correspond to varied two-dimensional spatial placements of said keyboard on said touch-sensitive display screen,
and wherein a typist can touch a section of said touch-sensitive display screen that displays an image of a key, such that each time that said section of said touch-sensitive display screen that displays an image of a key is touched, a corresponding input command is engaged for the sake of data entry.

11. A keyboard for controlling data input of alphanumeric characters and other commands including in combination:
a right section of said keyboard having a plurality of key switches and a left section of said keyboard having a plurality of key switches, said right section and said left section of said keyboard being spaced apart from each other at a fixed position;
a central input control pad for controlling data input, said central input control pad being located between said right section and said left section of said keyboard, said central input control pad having an elevation that is lower than said key switches of said right section and said left section of said keyboard; and
means for coupling said central input control pad and all said key switches with a processing device.

12. The combination according to claim 11 wherein said keyboard is housed within a laptop computer.

13. The combination according to claim 11 wherein said keyboard is housed within a tablet computer.

14. The combination according to claim 11 wherein said right section of said keyboard is comprised of a single home row of depressible keys,
and wherein said left section of said keyboard is comprised of a single home row of depressible keys,
and wherein a space bar is a depressible key,
and wherein said right section and said left section of said keyboard are set in a straight line relative to each other,
and wherein a touch-sensitive display screen can detect the presence of said keyboard when said keyboard is placed onto said touch-sensitive display screen,
and wherein images of keys appear on said touch-sensitive display screen when said keyboard is placed onto said touch-sensitive display screen, said images of keys being arrayed around said right section of said keyboard and said left section of said keyboard,
and wherein said images of keys arrayed around said right section of said keyboard and said left section of said keyboard move to correspond to varied two-dimensional spatial placements of said keyboard on said touch-sensitive display screen,
and wherein a typist can touch a section of said touch-sensitive display screen that displays an image of a key, such that each time that said section of said touch-sensitive display screen that displays an image of a key is touched, a corresponding input command is engaged for the sake of data entry,
and wherein said central input control pad is implemented by said touch-sensitive display screen.

15. The combination according to claim 11 wherein said right section of said keyboard is comprised of a single home row of depressible keys,
and wherein said left section of said keyboard is comprised of a single home row of depressible keys,
and wherein a space bar is a depressible key,
and wherein said right section and said left section of said keyboard are set at an oblique angle relative to each other, such that outer ends of said right section and said left section of said keyboard are set further away from a user of said keyboard than inner ends of said right section and said left section of said keyboard,
and wherein a touch-sensitive display screen can detect the presence of said keyboard when said keyboard is placed onto said touch-sensitive display screen,
and wherein images of keys appear on said touch-sensitive display screen when said keyboard is placed onto said touch-sensitive display screen, said images of keys being arrayed around said right section of said keyboard and said left section of said keyboard,
and wherein said images of keys arrayed around said right section of said keyboard and said left section of said keyboard move to correspond to varied two-dimensional spatial placements of said keyboard on said touch-sensitive display screen,
and wherein a typist can touch a section of said touch-sensitive display screen that displays an image of a key, such that each time that said section of said touch-sensitive display screen that displays an image of a key is touched, a corresponding input command is engaged for the sake of data entry,
and wherein said central input control pad is implemented by said touch-sensitive display screen.

16. The combination according to claim 11 wherein a home row for each said right section and each said left section of said keyboard have four depressible keys each,
and wherein a space bar is a depressible key,
and wherein all other keys of said right section and said left section of said keyboard are engaged by means of proximity-sensors.

17. A keyboard for controlling data input of alphanumeric characters and other commands including in combination:
a right section of said keyboard having a plurality of key switches and a left section of said keyboard having a plurality of key switches, said right section and said left section of said keyboard being spaced apart from each other;
a central input control pad for controlling data input, said central input control pad being located between said right section and said left section of said keyboard, said central input control pad having an elevation that is lower than said key switches of said right section and said left section of said keyboard;
said right section and said left section of said keyboard each being separately attached by way of pivots to a central body in which said central input control pad is housed, such that said right section and said left section can be rotated together into a stored position in which said right section and said left section are adjacent to each other lengthwise and
means for coupling said central input control pad and all said key switches with a processing device.

18. The combination according to claim 17 wherein a body containing a trackpad is connected by a hinge to said central body, said hinge being located on the side of said central body facing a user of said keyboard, said hinge providing movement of said body containing a trackpad back and forth between a functioning position in which said body containing a trackpad is closer to a user of said keyboard than said central body and such that said body containing a trackpad can be folded into a stored position on top of said right section and said left section of said keyboard when said right section and said left section have been rotated together into a stored position in which said right section and said left section are adjacent to each other lengthwise.

19. The combination according to claim 17 wherein an extension of said central body protrudes away from a user of said keyboard,
and wherein a pivoting hinge is housed at the end of said extension of said central body,
and wherein a body that houses a touch-sensitive display screen is attached by way of said pivoting hinge, such that said body that houses a touch-sensitive display screen can be folded up and down from a stored position adjacent to said right section and said left section of said keyboard when said right section and said left section have been rotated together into a stored position in which said right section and said left section are adjacent to each other lengthwise, and such that said body that houses a touch-sensitive display screen can be rotated by way of said pivoting hinge in such a manner that said touch-sensitive display screen can be positioned to face away from said right section and said left section of said keyboard when place in said stored position and can also be positioned to face said right section and said left section of said keyboard when placed in said stored position,
and wherein said touch-sensitive display screen can be used in conjunction with said keyboard.

20. The combination according to claim 17 wherein an extension of said central body protrudes away from a user of said keyboard,
and wherein a pivoting hinge is housed at the end of said extension of said central body,
and wherein a body that houses a touch-sensitive display screen is attached by way of said pivoting hinge, such that said body that houses a touch-sensitive display screen can be folded up and down from a stored position adjacent to said right section and said left section of said keyboard when said right section and said left section have been rotated together into a stored position in which said right section and said left section are adjacent to each other lengthwise, and such that said body that houses a touch-sensitive display screen can be rotated by way of said pivoting hinge in such a manner that said touch-sensitive display screen can be positioned to face away from said right section and said left section of said keyboard when place in said stored position and can also be positioned to face said right section and said left section of said keyboard when placed in said stored position,
and wherein said touch-sensitive display screen can be used in conjunction with said keyboard,
and wherein said processing device is housed within said body that houses a touch-sensitive display screen,
and wherein said body that houses a display screen can be detached by way of a release mechanism from said pivoting hinge for use without said keyboard.

21. The combination according to claim 17 wherein a body containing a trackpad is connected by a hinge to said central body, said hinge being located on the side of said central body facing a user of said keyboard, said hinge providing movement of said body containing a trackpad back and forth between a functioning position in which said body containing a trackpad is closer to a user of said keyboard than said central body and such that said body containing a trackpad can be folded into a stored position on top of said right section and said left section of said keyboard when said right section and said left section have been rotated together into a stored position in which said right section and said left section are adjacent to each other lengthwise,
and wherein an extension of said central body protrudes away from a user of said keyboard,
and wherein a pivoting hinge is housed at the end of said extension of said central body,
and wherein a body that houses a touch-sensitive display screen is attached by way of said pivoting hinge, such that said body that houses a touch-sensitive display screen can be folded up and down from a stored position on top of said body containing a trackpad when said body containing a trackpad is in a stored position, and such that said body that houses a touch-sensitive display screen can be rotated by way of said pivoting hinge in such a manner that said touch-sensitive display screen can be positioned to face away from said body containing a trackpad when both said body containing a trackpad and said body that houses a touch-sensitive display screen are placed in a stored position, and such that said body that houses a touch-sensitive display screen can also be positioned to face said body containing a trackpad when both said body containing a trackpad and said body that houses a touch-sensitive display screen are placed in said stored position,
and wherein said touch-sensitive display screen can be used in conjunction with said keyboard,
and wherein said processing device is housed within said body that houses a touch-sensitive display screen,
and wherein said body that houses a display screen can be detached by way of a release mechanism from said pivoting hinge for use without said keyboard.

22. The combination according to claim 17 wherein an extension of said central body protrudes away from a user of said keyboard,
and wherein a body is attached by way of a hinge to the end of said extension of said central body, such that said body can be folded down over said right section and said left section of said keyboard when said right section and said left section have been rotated together into a stored position in which said right section and said left section are adjacent to each other lengthwise,
and wherein said body contains at least one extension capable of holding a compact computerized device.

23. The combination according to claim 17 wherein a home row for each said right section and said left section of said keyboard have depressible keys,
and wherein a space bar is a depressible key,
and wherein all other keys of said right section and said left section of said keyboard are engaged by means of proximity-sensors
